(19) United States
(12) Patent Application Publication
(10) Pub. No.: US 2011/0233362 A1
(43) Pub. Date: Sep. 29, 2011

(54) MOUNTING BRACKET FOR SERVER

(75) Inventors: WEN-TANG PENG, Tu-Cheng (TW); WEI QIU, Shenzhen City (CN); ZHONG-YANG YAN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/771,082

(22) Filed: Apr. 30, 2010

(30) Foreign Application Priority Data
Mar. 24, 2010 (CN) 201010131894.X

(51) Int. Cl. F16M 13/00

(52) U.S. Cl. 248/316.8

(57) ABSTRACT

A mounting bracket includes a bottom panel and two guiding rails disposed on the bottom panel. The extending direction of the two guiding rails is parallel to a sliding direction of a server. The two guiding rails is configured to guide the server to slide in the mounting bracket along the sliding direction.

### BACKGROUND

1. Technical Field

The present disclosure relates to mounting brackets, especially to a mounting bracket for mounting servers.

2. Description of Related Art

Generally, a plurality of servers is mounted in a mounting bracket. The servers have sliding rails and the mounting bracket includes engaging portions corresponding to the sliding rails. However, there is another type of server, which has no sliding rails, and this type of server may not be mounted to the above mounting bracket.

### BRIEF DESCRIPTION OF THE DRAWINGS

FIG. 1 is a partially exploded, isometric view of a mounting bracket in accordance with an embodiment of the present disclosure, the mounting bracket includes two guiding rails.

FIG. 2 is an isometric view of the guiding rail of FIG. 1.

FIG. 3 is an assembled view of the mounting bracket of FIG. 1.

FIG. 4 is a pre-assembled view of a server and the mounting bracket of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

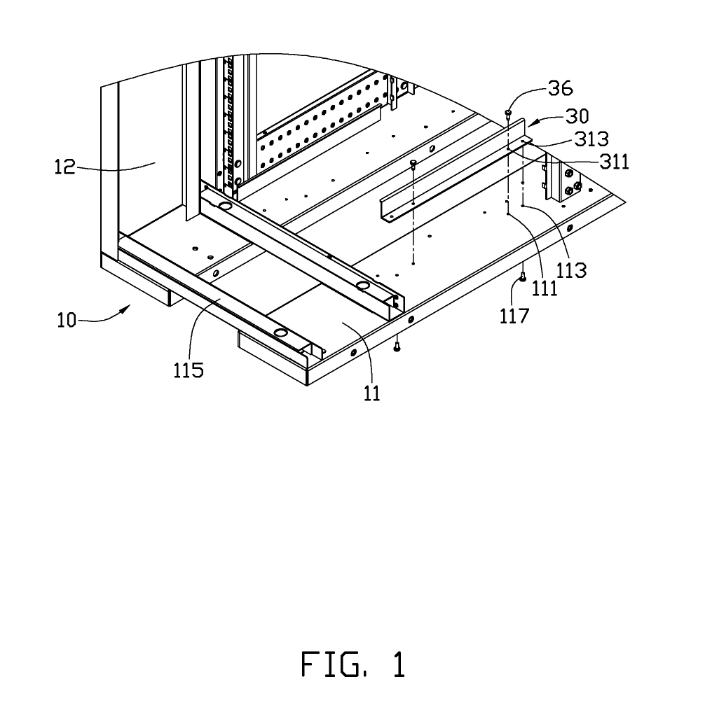

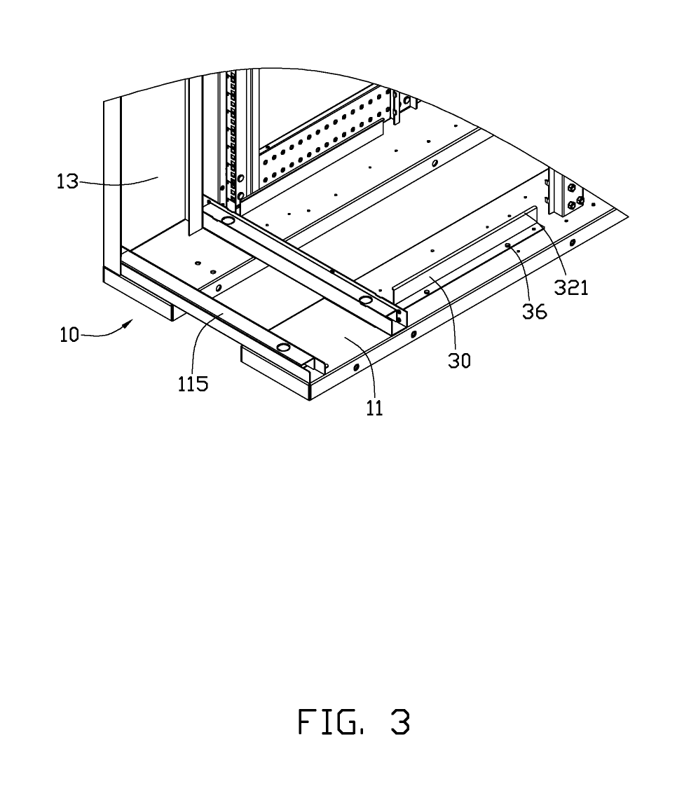

Referring to FIG. 1, a mounting bracket 10 includes a bottom panel 11, two side panels 12 extending at two opposite sides of the bottom panel 11, and two parallel guiding rails 30. The two side panels 12 are parallel to each other and perpendicular to the bottom panel 11. The mounting bracket 10 defines an entrance 13 (shown in FIG. 3). The bottom panel 11 defines a pair of first mounting holes 111 and a pair of second mounting holes 113. The bottom panel 11 includes two supporting elements 115. One supporting element 115 is placed adjacent to the entrance 13 and the other supporting element 115 is placed adjacent to the guiding rails 30.

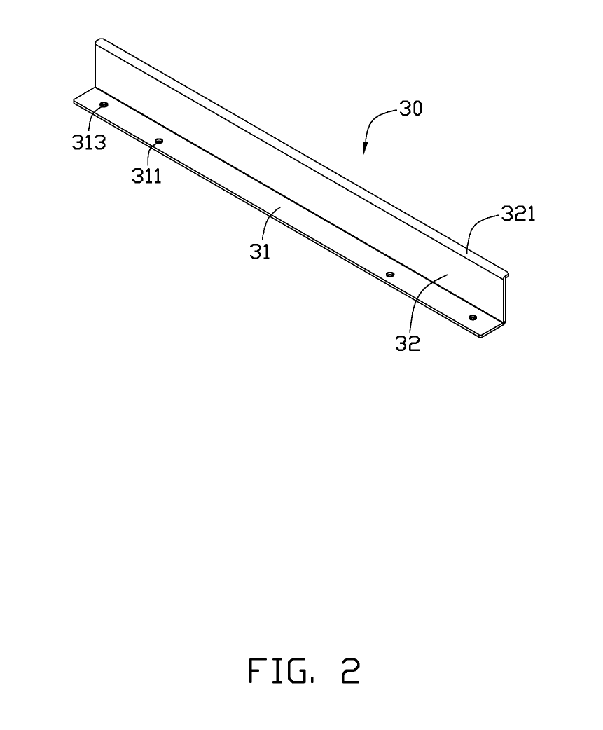

Referring to FIG. 2, the cross section of the guiding rail 30 is L-shaped. Each guiding rail 30 includes a securing portion 31 and a supporting portion 32 extending from the securing portion 31. The supporting portion 32 is perpendicular to the securing portion 31. The securing portion 31 defines a pair of first securing holes 311 corresponding to the first mounting holes 111 and a pair of second securing holes 313 corresponding to the second mounting holes 113. A guiding portion 321 extends from a free side of the supporting portion 32. The guiding portion 321 is parallel to the securing portion 31. The securing portion 31 and the guiding portion 321 are disposed at opposite sides of the supporting portion 32.

Referring to FIG. 3, in assembly of the guiding rails 30 to the bottom panel 11 of the mounting bracket 10, the first and second securing holes 311 and 313 of the guiding rails 30 are aligned with the first and second mounting holes 111 and 113 respectively. Four screws 36 are screwed into the first securing holes 311 and the first mounting holes 111 in a first direction, and four screws 117 are screwed into the second securing holes 313 and the second mounting holes 113 in a second direction opposite to the first direction, thereby securing the guiding rails 30 and the bottom panel 11 together. At this time, the guiding portions 321 face each other. The extending direction of the guiding rails 30 is perpendicular to the extending direction of the supporting elements 115.

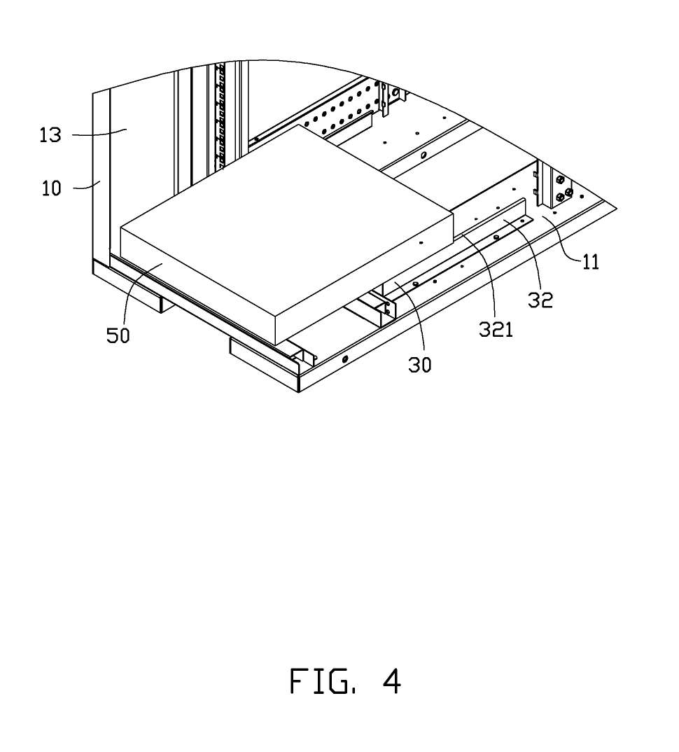

Referring to FIG. 4, in assembly of a sever 50 to the mounting bracket 10, the server 50 is moved into the entrance 13 of the mounting bracket 10. The server 50 slides into the guiding rails 30 via the supporting elements 115. Then, the server 50 slides along the mounting bracket 10 via the guiding portions 321 of the guiding rails 30, thereby mounting the server 50 in the mounting bracket 10.

In removal of the server 50, the server 50 is pulled outward to enable the sever 50 to slide outward via the guiding portions 321 of the guiding rails 30, and can thus be removed from the mounting bracket 10.

In another embodiment, the guiding rails 30 and the bottom panel 11 can be integrated.

It is to be understood, however, that even though numerous characteristics and advantages of the present invention have been set forth in the foregoing description, together with details of the structure and function of the disclosure, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mounting bracket, comprising:
a bottom panel; and
two guiding rails disposed on the bottom panel, an extending direction of each guiding rail is parallel to a sliding direction of a server; each guiding rail comprising a supporting portion, substantially perpendicular to the bottom panel, and a guiding portion, extending from the supporting portion; and the guiding portion configured to guide the server the server to slide in the mounting bracket along the sliding direction.

2. The mounting bracket of claim 1, wherein the guiding portions of the two guiding rails extend toward each other.

3. The mounting bracket of claim 2, wherein the guiding portions are substantially perpendicular to the supporting portion.

4. The mounting bracket of claim 1, wherein the guiding rail further comprises a securing portion extending from the supporting portion, and the securing portion is secured to the bottom panel.

5. The mounting bracket of claim 4, wherein the guiding portion and the securing portion are disposed at opposite sides of the supporting portion.

6. The mounting bracket of claim 4, wherein a cross section of the guiding rail is L-shaped.

7. The mounting bracket of claim 4, wherein the securing portion defines a first securing hole, and the bottom panel defines a first mounting hole corresponding to the first securing hole; a first screw is screwed into the first securing hole and the first mounting hole along a first direction.

8. The mounting bracket of claim 7, wherein the securing portion further defines a second securing hole, and the bottom panel further defines a second mounting hole corresponding to the second securing hole; a second screw is screwed into the second securing hole and the second mounting hole in a second direction opposite to the first direction.

9. The mounting bracket of claim 1, wherein the mounting bracket defines an entrance configured to allow the server to enter the mounting bracket, the bottom panel comprises a supporting element adjacent the entrance, an extending direction of the supporting element is substantially perpendicular to the extending direction of the guiding rail.

10. A mounting bracket, comprising:
a bottom panel;
two side panels substantially perpendicular to the bottom panel, an entrance defined between the two side panels; and
two guiding rails extending from the bottom panel and being placed between the two side panels; and the two guiding rails are configured to support and guide a server to slide into the mounting bracket from the entrance.

11. The mounting bracket of claim 10, wherein each guiding rail comprises a supporting portion substantially perpendicular to the bottom panel and a guiding portion extending from the supporting portion, and the guiding portion configured to guide the server.

12. The mounting bracket of claim 11, wherein the guiding portions of the two guiding rails extend towards each other.

13. The mounting bracket of claim 12, wherein the guiding portion are substantially perpendicular to the supporting portion.

14. The mounting bracket of claim 11, wherein the guiding rail further comprises a securing portion extending from the supporting portion, and the securing portion is secured on the bottom panel.

15. The mounting bracket of claim 14, wherein the guiding portion and the securing portion are disposed at opposite sides of the supporting portion.

16. The mounting bracket of claim 14, wherein a cross section of the guiding rail is L-shaped.

17. The mounting bracket of claim 14, wherein the securing portion defines a first securing hole, and the bottom panel defines a first mounting hole corresponding to the first securing hole; a first screw is screwed into the first securing hole and the first mounting hole in a first direction.

18. The mounting bracket of claim 17, wherein the securing portion further defines a second securing hole, and the bottom panel further defines a second mounting hole corresponding to the second securing hole; and a second screw is screwed into the second securing hole and the second mounting hole in a second direction opposite to the first direction.

19. The mounting bracket of claim 10, wherein the bottom panel comprises a supporting element adjacent the entrance, and an extending direction of the supporting element is substantially perpendicular to the extending direction of the guiding rail.
